(19) United States
(12) Patent Application Publication
(10) Pub. No.: US 2026/0122580 A1
(43) Pub. Date: Apr. 30, 2026

(54) DATA PROCESSING METHOD, ELECTRONIC DEVICE, AND STORAGE MEDIUM

(71) Applicant: Lenovo (Beijing) Limited, Beijing (CN)

(72) Inventor: Hua SHAO, Beijing (CN)

(21) Appl. No.: 19/374,800

(22) Filed: Oct. 30, 2025

(30) Foreign Application Priority Data
Oct. 31, 2024 (CN) 202411547236.7

(51) Int. Cl. H04W 52/02; H04W 76/15

(52) U.S. Cl. CPC H04W 52/0277; H04W 76/15

(57) ABSTRACT

A data processing method applied to a first electronic device includes: establishing a channel between the first electronic device and at least one second electronic device; controlling the first electronic device to supply power to the at least one second electronic device through the channel; obtaining status information of the at least one second electronic device through the channel in response to a first signal, where the first signal indicates that the power supply condition meets a target condition; and detecting the at least one second electronic device based on the status information.

### CROSS-REFERENCE TO RELATED APPLICATION

This application claims priority to Chinese Patent Application No. 202411547236.7, filed on October 31, 2024, the entire content of which is incorporated herein by reference.

### TECHNICAL FIELD

The present disclosure generally relates to the field of data processing and, more particularly, to a data processing method and an electronic device.

### BACKGROUND

When an electronic device needs to be detected, many manual operations are usually required. For example, when a laptop computer has not been used for a long time, in order to detect it, it is necessary to first charge the laptop computer. When the charge reaches a certain level, the laptop computer is turned on such that the laptop computer starts to run. The detection is then carried out while the computer is running. This process requires manual operations. And, when there are a large number of electronic devices, it takes a long time to complete the detection.

### SUMMARY

In accordance with the present disclosure, there is provided a data processing method applied to a first electronic device. The method includes: establishing a channel between the first electronic device and at least one second electronic device; controlling the first electronic device to supply power to the at least one second electronic device through the channel; obtaining status information of the at least one second electronic device through the channel in response to a first signal, where the first signal indicates that the power supply condition meets a target condition; and detecting the at least one second electronic device based on the status information.

Also in accordance with the present disclosure, there is provided a data processing method applied to a second electronic device. The method includes: establishing a channel between the second electronic device and a first electronic device, wherein the channel is used for the first electronic device to supply power to the second electronic device; and in response to a first signal, outputting status information to the first electronic device via the channel, such that the first electronic device detects the second electronic device based on the status information, wherein the first signal indicates that the power supply condition meets a target condition.

Also in accordance with the present disclosure, there is provided an electronic device. The device includes: at least one target interface, configured to connect to at least one second electronic device and establish a channel with the at least one second electronic device; a power supply module, configured to supply power to the at least one second electronic device through the channel; and a processor, configured to obtain status information of the at least one second electronic device through the channel in response to a first signal indicating that the power supply condition meets a target condition; and detect the at least one second electronic device based on the status information.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a flow chart of an exemplary data processing method consistent with various embodiments of the present disclosure.

FIG. 2 is a flow chart of another exemplary data processing method consistent with various embodiments of the present disclosure.

FIG. 3 is a flow chart of another exemplary data processing method consistent with various embodiments of the present disclosure.

FIG. 4 is a flow chart of another exemplary data processing method consistent with various embodiments of the present disclosure.

FIG. 5 is a schematic diagram of a system architecture for implementing a data processing method consistent with various embodiments of the present disclosure.

FIG. 6 is a flow chart of another exemplary data processing method consistent with various embodiments of the present disclosure.

FIG. 7 is a schematic structural diagram of an electronic device consistent with various embodiments of the present disclosure.

### DETAILED DESCRIPTION OF THE EMBODIMENTS

Specific embodiments of the present disclosure are hereinafter described with reference to the accompanying drawings. The embodiments described are merely examples of the present disclosure and should not be regarded as limitations of this application. All other embodiments obtained by those of ordinary skill in the art without creative efforts fall within the scope of protection of the present disclosure.

Unless otherwise defined, all technical and scientific terms used in the present disclosure have the same meaning as those generally understood by those skilled in the art to which the present disclosure belongs. The terms used herein are only for the purpose of describing the present disclosure and are not intended to limit the scope of the present disclosure.

In the following description, “some embodiments”, “this embodiment”, one embodiment”, and “examples”, etc., describe subsets of all possible embodiments. But it is understood that “some embodiments” can be the same subset or different subsets of all possible embodiments and can be combined with each other without conflict.

In the following description, the terms “first/second/third” or similar terms involved are only used to distinguish similar objects, and do not represent a specific order for the objects. It is understandable that items described by “first/second/third” may be interchanged with a specific order or sequence where permitted, such that the present disclosure described here can be implemented in an order other than that illustrated or described here.

In the present disclosure, the term “and/or” is only a kind of association relationship describing associated objects, indicating that there can be three types of relationships. For example, “object A and/or object B” may represent object A exists alone, object A and object B exist at the same time, or object B exists alone. The terms “including”, “comprising”, “having”, and any variations thereof, are intended to cover a non-exclusive inclusion, such that a process, method, system, product, or apparatus that comprises a list of elements is not necessarily limited to those elements but may include other elements not expressly listed or inherent to such process, method, product, or apparatus.

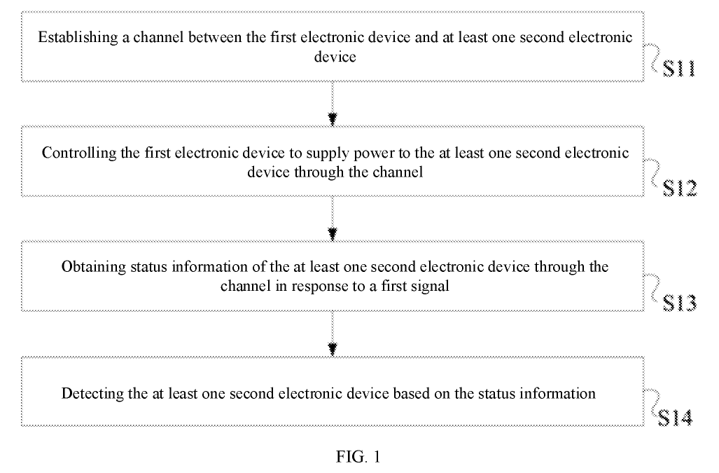

The present disclosure provides a data processing method applied to a first electronic device. As shown in FIG. 1, in one embodiment, the data processing method may include:

S11: establishing a channel between the first electronic device and at least one second electronic device.

S12: the first electronic device supplying power to the at least one second electronic device via the channel;

S13: in response to a first signal, obtaining status information of the at least one second electronic device via the channel, where the first signal indicates that the power supply condition meets a target condition; and

S14: detecting at least one second electronic device based on the status information.

When an electronic device has not been used for an extended period, detecting it requires first charging the device and then powering it on before detecting can be performed. For example, if that a laptop computer has not been used for an extended period, detecting it requires first charging the laptop computer. In response to that the charge reaches a certain level, the laptop computer is powered on and running, and then is detected while it is powered on. This process requires manual operations and, when detecting a large number of electronic devices, it may take a long time to complete.

In the present disclosure, the at least one second electronic device to be detected may be controlled to connect with the first electronic device, and establish the channel through this connection. Through this channel, the first electronic device may supply power to the at least one second electronic device. If the power supply condition meets the target condition, the first electronic device may obtain the status information of the at least one second electronic device through this channel and perform detecting on the at least one second electronic device based on this status information. The goal of automatically detecting the at least one second electronic device may be achieved, eliminating the need for manual user operations. Furthermore, the at least one second electronic device may be detected simultaneously, saving time and improving detecting efficiency, compared to detecting multiple second electronic devices one by one.

In one embodiment, when an electronic device requires detecting, the electronic device to be detected may be identified as one second electronic device. The second electronic device may be physically connected to the first electronic device which is capable of detecting electronic devices. This physical connection may establish a channel between the first electronic device and the second electronic device.

The channel between the first electronic device and the at least one second electronic device may be able to transmit both signals and power. The channel may connect an interface on the first electronic device to an interface on the at least one second electronic device via a transmission line. The interface on the first electronic device and/or the interface on the at least one second electronic device may be a USB interface (for example, a Type-C interface), but other interfaces are also possible and are not specifically limited here.

In this embodiment, the first electronic device may act as an detecting device for detecting the at least one second electronic device. Upon determining that the channel is established between the first electronic device and the at least one second electronic device, the first electronic device may automatically supply power to the at least one second electronic device through the channel. This may ensure that the detect process for the at least one second electronic device is initiated as soon as the channel is established.

The first electronic device may include a built-in security chip that matches a security chip of the at least one second electronic device. Furthermore, the first electronic device may include a built-in root certificate that complies with security specifications and cannot be accessed internally or externally. This may ensure that both the first electronic device and the at least one second electronic device are secure devices, and that information transmitted between the first electronic device and the at least one second electronic device is secure and cannot be intercepted.

The first electronic device may supply power to the at least one second electronic device using its own battery. Alternatively, to ensure proper operation of the first electronic device, the first electronic device may not directly supply power to the at least one second electronic device using its internal battery. Instead, an external power source may be connected to the first electronic device. The first electronic device may receive power from the external power source and transmit the power to the at least one second electronic device via the channel between the first electronic device and the at least one second electronic device, thereby powering the at least one second electronic device.

Since the at least one second electronic device has been unused for an extended period of time, to ensure electrical safety and the lifespan of the at least one second electronic device, there may be no power supply to the at least one second electronic device, or the battery within the at least one second electronic device may be depleted. Therefore, in this situation, power must first be supplied to the at least one second electronic device such that the battery within it is able to receive power. Once the battery within the at least one second electronic device receives power, the at least one second electronic device may be detected.

Thus, while the first electronic device is supplying power to the at least one second electronic device through the channel, the power supply condition may be monitored to determine whether it meets the target condition. If not, power may continue to be supplied to the at least one second electronic device through the first electronic device. If the target condition is met, the subsequent detecting process may be initiated.

If it is determined that the power supply condition meets the target condition, the first signal may be generated. In response to the first signal, the first electronic device may obtain the status information of the at least one second electronic device via the channel between the first electronic device and the at least one second electronic device.

The status information may include information that is able to represent the status of each component in the at least one second electronic device. If the power supply condition meets the target condition, the at least one second electronic device may detect the status information of each component within it and transmit this detected status information to the first electronic device via the channel between the first electronic device and the at least one second electronic device. At this point, the first electronic device may no longer supply power to the at least one second electronic device via this channel, but instead may obtain the status information of the at least one second electronic device via this channel and then may detect the at least one second electronic device based on this status information. This may enable automatic detection of at least one second electronic device via the channel between the first electronic device and the at least one second electronic device, eliminating the need for manual user operation and simplifying the detection process.

In one embodiment, the first electronic device may establish a channel with only one second electronic device at a time, and may only detect one second electronic device at a time through the channel. In some other embodiments, the first electronic device may establish channels with multiple second electronic devices simultaneously, and may detect the multiple second electronic devices at the same time through the channels.

The first electronic device may include multiple interfaces, and may be connected to multiple different second electronic devices through the interfaces. Each second electronic device may be a second electronic device to be detected, and each second electronic device may not need to be powered on when connected to the first electronic device.

When the first electronic device is connected to multiple second electronic devices, the channels may be established between the first electronic device and each of the multiple second electronic devices. For example, when the first interface of the first electronic device A is connected to the second electronic device B1, the second interface of first electronic device A is connected to the second electronic device B2, and the third interface of the first electronic device A is connected to the second electronic device B3, a first channel AB1 is established between the first electronic device A and the second electronic device B1, a second channel AB2 is established between the first electronic device A and the second electronic device B2, and a third channel AB3 is established between the first electronic device A and the second electronic device B3.

If the first electronic device establishes the channel with the multiple second electronic devices, the first electronic device may supply power to the corresponding second electronic devices through the channels. The power supply conditions for different second electronic devices provided by the first electronic device may or may not meet the target conditions simultaneously.

If the power supply conditions for different second electronic devices provided by the first electronic device meet the target conditions simultaneously, that is, when the first electronic device provides power to the multiple second electronic devices and the power supply conditions for different second electronic devices meet the target conditions simultaneously, the first electronic device may simultaneously obtain the status information for different second electronic devices through corresponding channels.

For example, when the first electronic device A provides power to the second electronic devices B1, B2, and B3, and at a certain moment it is determined that the power supply condition for the second electronic device B1 meets the target condition, and at the same time, the power supply condition for the second electronic device B2 also meets the target condition, and the power supply condition for the second electronic device B3 also meets the target condition, the first electronic device A may simultaneously obtain the status information for the second electronic devices B1, B2, and B3.

If the power supply conditions for different second electronic devices provided by the first electronic device do not meet the target condition simultaneously, the status information of the corresponding second electronic devices may be obtained based on the order in which the target condition is met.

For example, the first electronic device A provides power to the second electronic device B1, the second electronic device B2, and the second electronic device B3. At a first time t1, it is determined that the power supply condition for the second electronic device B1 meets the target condition. At a second time t2, it is determined that the power supply condition for the second electronic device B2 meets the target condition. At a third time t3, it is determined that the power supply condition for the second electronic device B3 meets the target condition. Therefore, the status information of the second electronic devices B1, B2, and B3 may be obtained sequentially based on the order of the first time t1, the second time t2, and the third time t3.

That is, as long as the power supply condition for a particular second electronic device meets the target condition, the first electronic device may obtain the status information of this particular second electronic device, without having to wait for the power supply conditions for other second electronic devices to meet the target condition to obtain the status information of all second electronic devices simultaneously.

Of course, in some other embodiments, if the power supply conditions provided by the first electronic device to different second electronic devices may not meet the target condition simultaneously, the first electronic device may wait until the power supply conditions provided to all second electronic devices meet the target condition before simultaneously obtaining the status information of each second electronic device.

The first electronic device may detect the at least one second electronic device based on the status information. The first electronic device may obtain the status information of the at least one second electronic device, analyze the status information, and directly complete the detection of the at least one second electronic device. For example, the first electronic device may directly determine based on the status information that the at least one second electronic device is in a normal operating state, or determine based on the status information that a specific component in the at least one second electronic device is abnormal.

In some other embodiments, the first electronic device may obtain the status information of the at least one second electronic device and then transmit the status information of the at least one second electronic device to another device or server connected to the first electronic device. The other device or server may then detect the status information of the at least one second electronic device, determine the actual status of the at least one second electronic device, and transmit the obtained actual status of the at least one second electronic device to the first electronic device to complete the detecting of the at least one second electronic device. The first electronic device and the at least one second electronic device may establish the channel through a physical connection. The first electronic device and the other device or server may also be connected wirelessly or physically, which will not be described in detail here.

The data processing method provided by the present disclosure may be applied to the first electronic device, where the channel is established between the first electronic device and the at least one second electronic device. The first electronic device may supply power to the at least one second electronic device through the channel. In response to the first signal, the status information of the at least one second electronic device may be obtained through the channel, where the first signal indicates that the power supply condition meets the target condition. And then the at least one second electronic device may be detected based on the status information. In the present disclosure, when detecting the at least one second electronic device through the first electronic device, when the channel is established between the first electronic device and the at least one second electronic device, the first electronic device may first supply power to the at least one second electronic device through the channel, such that the status information of the at least one second electronic device is obtained through the channel if the power supply condition meets the target condition, and then the at least one second electronic device may be detected based on the status information. The entire process may not require manual operations of the user, and the at least one second electronic device to be detected may be powered through the channel established between the devices, and the status information may be transmitted through the same channel, thereby realizing an automatic detecting process and improving the detecting efficiency of the at least one second electronic device.

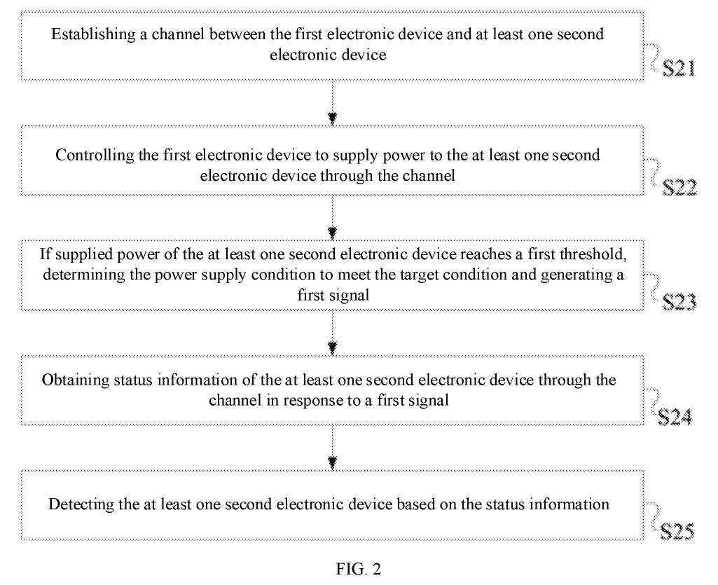

Another embodiment provides another data processing method applied to the first electronic device. As shown in FIG. 2, in another embodiment, the data processing method may include:

S21: establishing a channel between the first electronic device and the at least one second electronic device;

S22: the first electronic device supplying power to the at least one second electronic device via the channel;

S23: If the amount of power supplied by the first electronic device to the at least one second electronic device reaches a first threshold, determining that the power supply condition meets the target condition and generating the first signal;

S24: in response to the first signal, obtaining the status information of the at least one second electronic device via the channel; and

S25: detecting the at least one second electronic device based on the status information.

Connecting the first electronic device to the at least one second electronic device may establish the channel between the first electronic device and the at least one second electronic device. Through this channel, the first electronic device may supply power to the at least one second electronic device, ensuring that the at least one second electronic device has sufficient power and ensuring accurate detecting of the at least one second electronic device.

While the first electronic device supplies power to the at least one second electronic device via the channel, the first electronic device may monitor the amount of power supplied to the at least one second electronic device to determine whether the supplied power has reached the first threshold. Based on whether the supplied power reaches the first threshold, the first electronic device may determine whether the amount of power supplied to the at least one second electronic device meets the target condition. If the amount of power supplied by the first electronic device to the at least one second electronic device reaches the first threshold, it may be determined that the amount of power obtained by the at least one second electronic device meets the target condition. In this case, the first electronic device may no longer supply power to the at least one second electronic device, but instead generate the first signal. In response to the first signal, the first electronic device may obtain the status information of the at least one second electronic device via the channel between the first electronic device and the at least one second electronic device, thereby detecting the at least one second electronic device using the status information.

If the amount of power supplied by the first electronic device to the at least one second electronic device does not reach the first threshold, it may be determined that the amount of power obtained by the at least one second electronic device does not meet the target condition. In this case, the first electronic device may continue to supply power to the at least one second electronic device via the channel between the first electronic device and the at least one second electronic device.

It should be noted that, the amount of power supplied by the first electronic device to the at least one second electronic device reaching the first threshold, may include that, if the number of the at least one second electronic device is one, the amount of power supplied by the first electronic device to the one second electronic device meets the first threshold. If the number of the at least one second electronic device is larger than one, the first threshold may be applied to each second electronic device or to all second electronic devices.

For example, if the first threshold is applied to each second electronic device, the first electronic device may determine the amount of power supplied to each second electronic device, which may be monitored via an interface connected to the channel on the first electronic device. If the power supply provided by the first electronic device to the second electronic device K1 reaches the first threshold, the first electronic device may then obtain status information of the second electronic device K1 through the channel between the first electronic device and the second electronic device K1, and detect the second electronic device K1 based on this status information. If the power supply provided by the first electronic device to the second electronic device K2 does not reach the first threshold, the first electronic device may continue to supply power to the second electronic device K2 until the supplied power reaches the first threshold, and then stop supplying power. The first electronic device may obtain the status information of the second electronic device K2 through the channel between the first electronic device and the second electronic device K2, and detect the second electronic device K2 based on this status information.

Of course, in some other embodiments, determining whether the supplied power of the at least one second electronic device reaches the first threshold may also be monitored by each second electronic device. Each second electronic device may send the power supplied by the first electronic device to the first electronic device, which then determines whether the power supplied to the second electronic device reaches the first threshold. Or, each second electronic device may monitor, compare the supplied power monitored by the second electronic device with the first threshold, determine whether the first threshold is reached, and send the comparison result to the first electronic device, which then determines whether to continue supplying power to the second electronic device based on the comparison result.

When the first threshold applies to all the second electronic devices, the first electronic device may determine the power it provides to all the second electronic devices. This approach may be applicable when the first electronic device is simultaneously powering multiple second electronic devices.

The power provided to each second electronic device by the first electronic device may be monitored via interfaces of the channel on the first electronic device. The power provided by all channel interfaces may be summed to obtain the power provided by the first electronic device to all the second electronic devices. If this power reaches the first threshold, the first electronic device may no longer supply power to any second electronic device and instead obtains the status information of each second electronic device through the channels between the second electronic device and the first electronic device, allowing the first electronic device to detect each second electronic device. If the power provided to all second electronic devices by the first electronic device does not reach the first threshold, the first electronic device may continue to supply power to each second electronic device until the power provided to all second electronic devices reaches the first threshold. At this point, the first electronic device may no longer supply power to any second electronic device and may obtain the status information of each second electronic device through the channels between the second electronic device and the first electronic device, allowing the first electronic device to detect each second electronic device.

In the data processing method provided by this embodiment, the channel between the first electronic device and the at least one second electronic device may be established. The first electronic device may supply power to the at least one second electronic device through the channel. If the power supplied by the first electronic device to the at least one second electronic device reaches the first threshold, it may be determined that the power supply condition meets the target condition and the first signal may be generated. The status information of the at least one second electronic device may be obtained through the channel in response to the first signal, and the at least one second electronic device may be detected based on the status information. Therefore, when the first electronic device supplies power to the at least one second electronic device through the channel between the first electronic device and the at least one second electronic device, the first electronic device may monitor the power supplied to the at least one second electronic device. If the supplied power reaches the first threshold, the status information of the at least one second electronic device may be obtained through the channel to ensure that the status information of the at least one second electronic device is obtained only if sufficient power is provided to the at least one second electronic device, and that the status information of the at least one second electronic device obtained is obtained with sufficient power support, thereby ensuring the accuracy of data detection.

In some embodiments, in the data processing method, determining whether the power supply condition meets the target condition may also include: determining that the power supply condition meets the target condition if the duration for which the first electronic device provides power to the at least one second electronic device reaches a second threshold.

The first electronic device may monitor the duration for which it provides power to the at least one second electronic device, to determine whether the duration reaches the second threshold. If the duration reaches the second threshold, the power supply condition may be determined to meet the target condition. At this point, the first electronic device may stop providing power to the at least one second electronic device and obtain the status information of the at least one second electronic device through the channel between the first electronic device and the at least one second electronic device. If the duration does not reach the second threshold, the first electronic device may continue to supply power to the at least one second electronic device until the duration for which the power is provided to the at least one second electronic device reaches the second threshold.

Determining whether the duration for which the first electronic device provides power to the at least one second electronic device reaches the second threshold may include determining whether the duration for which the first electronic device provides power to each second electronic device reaches the second threshold. If the duration for which the power is provided to one particular second electronic device reaches the second threshold, supplying power to that particular second electronic device may be stopped. However, when other second electronic devices are present at the same time and the duration for which the first electronic device provides power to the other second electronic devices does not reach the second threshold, stopping power supply for that particular second electronic device may not affect the first electronic device’s ability to supply power to the other second electronic devices.

Determining the duration for which the first electronic device supplies power to each second electronic device may also be achieved by monitoring through the interface of the channel between the first electronic device and each second electronic device. Different interfaces may be connected to different second electronic devices, such that the duration for which the first electronic device supplies power to different second electronic devices may be monitored through different interfaces.

In some other embodiments, determining the duration for which the first electronic device supplies power to the at least one second electronic device may also be achieved by monitoring by each second electronic device. Each second electronic device may monitor the duration for which the first electronic device supplies power to the second electronic device and transmit the duration back to the first electronic device. The first electronic device may then determine whether the power supply duration has reached the second threshold, whether to continue supplying power, generate the first signal, and obtain the status information of the second electronic device through the channel with the second electronic device. Or, each second electronic device may monitor the duration of power received from the first electronic device and determine whether the duration reaches the second threshold. A comparison result may be obtained and transmitted to the first electronic device. Based on the comparison result, the first electronic device may determine whether to continue supplying power to the second electronic device, generate the first signal, and obtain the status information of the second electronic device through the channel with the second electronic device.

In the data processing method disclosed in this embodiment, it may be ensured that the status information of the at least one second electronic device is obtained only if the charging time of the at least one second electronic device reaches the second threshold, ensuring that the obtained status information of the at least one second electronic device is obtained if there is sufficient power support, thereby ensuring the accuracy of data detecting.

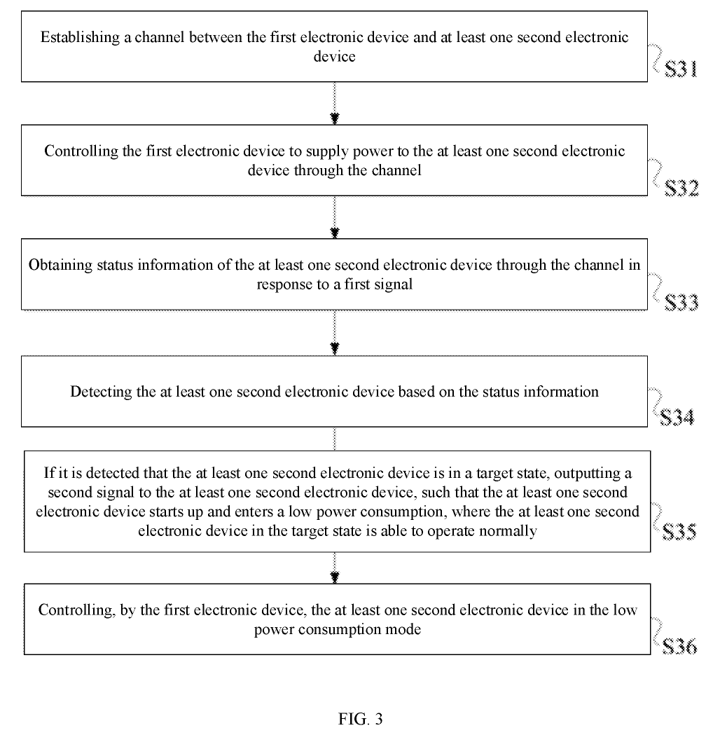

Another embodiment of the present disclosure provides another data processing method, which is applied to the first electronic device. As shown in FIG. 3, in this embodiment, the data processing method may include:

S31: establishing the channel between the first electronic device and the at least one second electronic device;

S32: the first electronic device supplying power to the at least one second electronic device through the channel;

S33: in response to the first signal, obtaining the status information of the at least one second electronic device through the channel, wherein the first signal indicates that the power supply condition meets the target condition;

S34: detecting the at least one second electronic device based on the status information;

S35: when the at least one second electronic device is detected to be in a target state, outputting a second signal to the at least one second electronic device such that the at least one second electronic device is turned on and enters a low-power mode, wherein one second electronic device is able to operate normally in the target state; and

S36: the first electronic device controlling the at least one second electronic device in the low-power mode.

When the channel is established between the first electronic device and the at least one second electronic device and power is supplied to the at least one second electronic device through the channel, if the power supply condition meets the target condition, the status information of the at least one second electronic device may be obtained and the at least one second electronic device may be detected based on the status information.

The first electronic device may detect the at least one second electronic device based on the status information to determine whether the at least one second electronic device is able to operate normally.

One second electronic device determined to be in the target state based on the status information may mean that the second electronic device is capable of operating normally, and all parameters in the status information of each component in the second electronic device are within a normal range, indicating that each component in the second electronic device is capable of operating normally when the second electronic device is powered on. When one second electronic device is determined not to be in the target state based on the status information, the second electronic device may be unable to operate normally, and then the parameters of a component in the status information of each component in the second electronic device may be outside the normal range, causing the component in the second electronic device to be unable to operate normally when the second electronic device is powered on.

When the first electronic device detects the at least one second electronic device is in the target state based on the status information, the first electronic device may directly output the second signal to second electronic devices in the target state, causing the second electronic devices in the target state to start up and enter the low-power mode. For example, the second signal may be a signal generated and output by the first electronic device that causes the second electronic device to start up and enter a low-power mode.

When the first electronic device determines that one second electronic device is capable of operating normally, the first electronic device may control the second electronic device to start up and enter the low-power mode.

Since the second electronic device is powered off when the first electronic device begins detecting it, to reduce manual user intervention, the first electronic device may automatically perform detecting while the second electronic device is powered off, eliminating the need for powering on. When the second electronic device is a laptop, two bodies of the second electronic device may be in a closed state when the first electronic device detects it. For example, a first body including a display screen and the second body including a keyboard may be in the closed state. Upon determining that the second electronic device is in the target state, the first electronic device may output the second signal to the second electronic device, such that the second electronic device is powered on. In other words, the first electronic device may control the second electronic device to be powered on while in the closed state, without requiring the first and second bodies of the second electronic device to be in an open state.

Of course, the second signal output by the first electronic device to the second electronic device, in addition to controlling the second electronic device to power on and enter the low-power mode, may also control the relationship between the first and second bodies of the second electronic device to switch from the closed state to the open state, i.e., automatically control the angle between the first and second bodies of the second electronic device through the second signal. Whether the second signal controls the angle between the first and second bodies of the second electronic device to change is not specifically limited in the present disclosure.

After the first electronic device outputs the second signal to the second electronic device, the second electronic device may power on and enter the low-power mode. While in the low-power mode, the second electronic device may continue to receive other signals from the first electronic device, allowing the first electronic device to further detect or directly control the second electronic device based on the other signals. Alternatively, while in the low-power mode, the second electronic device may no longer receive control or detect signals from the first electronic device, but may instead directly receive control or detect signals from the user or a server.

After the first electronic device detects all second electronic devices connected to it based on the status information of the at least one second electronic device connected to it and controls any second electronic devices in the target state to power on and enter the low-power mode, the first electronic device may no longer have any second electronic devices connected to it that need detecting. At this point, the first electronic device may no longer need to maintain a high power consumption state and may directly enter the low-power mode.

After the first electronic device enters the low-power mode, when control of one second electronic device is required, the first electronic device may control the second electronic device while in the low-power mode.

In the data processing method provided by this embodiment, the channel between the first electronic device and the at least one second electronic device may be established. The first electronic device may supply power to the at least one second electronic device through the channel, and may obtain the status information of the at least one second electronic device through the channel in response to the first signal. The first signal may indicate that the power supply condition meets the target condition. The first electronic device may detect the at least one second electronic device based on the status information. When the at least one second electronic device is detected to be in the target state, the second signal may be output to the at least one second electronic device to enable the at least one second electronic device to start up and enter the low-power mode, enabling second electronic devices in the target state to operate normally. The first electronic device may control the at least one second electronic device in the low-power mode. Therefore, after the first electronic device obtains the status information of the at least one second electronic device, it may detect the at least one second electronic device based on the status information. When it is determined that the at least one second electronic device is currently in the target state, the first electronic device may control the at least one second electronic device to start up and enter the low-power mode, and further control the at least one second electronic device while in the low-power mode, thereby achieving further detecting or control of the at least one second electronic device, ensuring detecting accuracy, and improving detecting and control efficiency.

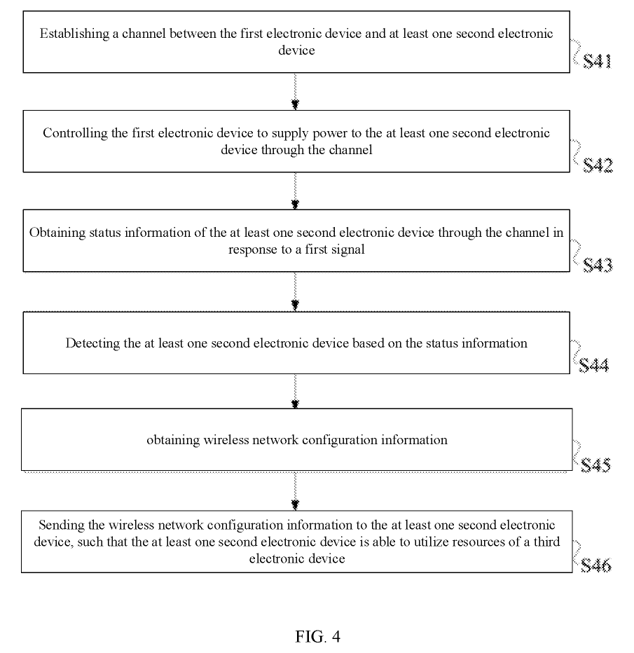

Another embodiment of the present disclosure provides another data processing method, which is applied to the first electronic device. As shown in FIG. 4, in this embodiment, the data processing method may include:

S41: establishing the channel between the first electronic device and the at least one second electronic device;

S42: the first electronic device supplying power to the at least one second electronic device through the channel;

S43: in response to the first signal, obtaining the status information of the at least one second electronic device through the channel, wherein the first signal indicates that the power supply condition meets the target condition;

S44: supplying power to the at least one second electronic device based on the status information;

S45: obtaining wireless network configuration information; and

S46: sending the wireless network configuration information to the at least one second electronic device, to enable the at least one second electronic device to utilize resources of a third electronic device, wherein the third electronic device is a device targeted by the wireless network configuration information.

When the at least one second electronic device requires detecting, the channel may be established between the first electronic device and the at least one second electronic device, and the first electronic device may supply power to the at least one second electronic device through the channel. If the power supply meets the target condition, the first electronic device may obtain the status information of the at least one second electronic device through the channel and detect the at least one second electronic device based on the status information.

After the first electronic device completes the detecting of the at least one second electronic device, it may directly control the at least one second electronic device to establish a wireless connection with the third electronic device, enabling the at least one second electronic device to utilize the resources of the third electronic device.

For example, once the first electronic device completes the detecting of the at least one second electronic device, regardless of whether the detected second electronic device is able to operate normally, the first electronic device may control the second electronic device to wirelessly connect to the third electronic device, such that the third electronic device may be used to further detect the second electronic device or control the second electronic device.

Alternatively, in some other embodiment, after the first electronic device completes the detecting of the at least one second electronic device, it may be determined whether one second electronic device is in the target state, and based on whether the second electronic device is in the target state, determine whether to control the second electronic device to wirelessly connect to the third electronic device, where the second electronic device in the target state is able to operate normally.

When the first electronic device determines that one second electronic device is in the target state, it may control the second electronic device to wirelessly connect to the third electronic device, enabling the second electronic device to utilize the resources of the third electronic device, thereby enabling the second electronic device to perform upgrades or other operations based on the resources of the third electronic device.

When the first electronic device determines that one second electronic device is not in the target state, it may not need to control the second electronic device to wirelessly connect to the third electronic device. Only when the second electronic device is operating normally, the first electronic device may control the second electronic device to wirelessly connect to the third electronic device, to further detect or control the second electronic device. Alternatively, when the first electronic device determines that one second electronic device is not in the target state, it may also control the second electronic device to wirelessly connect to the third electronic device, enabling the second electronic device to utilize the resources of the third electronic device, thereby enabling the second electronic device to perform further detecting based on the resources of the third electronic device to further determine the specific circumstances under which the second electronic device is not operating normally.

In one embodiment, the first electronic device may control the second electronic device to wirelessly connect to the third electronic device by: after obtaining wireless network configuration information, the first electronic device transmits the wireless network configuration information to the at least one second electronic device, enabling the at least one second electronic device to wirelessly connect to the third electronic device and utilize the resources of the third electronic device. The third electronic device may be a device targeted by the wireless network configuration information.

The first electronic device may receive wireless network UDP (User Datagram Protocol) packets in a listening mode, encode them using UDP length encoding to obtain the wireless network configuration information.

UDP is a connectionless, datagram-oriented transport layer protocol. When the first electronic device is powered on for the first time, it may enter a network configuration mode to connect to a wireless network. When no network connection is established, the first electronic device may monitor network information transmitted over the air. When it detects a UDP broadcast and determines that the UDP broadcast conforms to the encoding pattern, it may decode the broadcast and obtain the wireless network identifier and password corresponding to the UDP broadcast, thereby obtaining the wireless network configuration information, enabling the first electronic device to communicate with the server.

After obtaining the wireless network configuration information, the first electronic device may transmit the wireless network configuration information to the at least one second electronic device via the channel between the first electronic device and the at least one second electronic device. When the first electronic device transmits the wireless network configuration information to the at least one second electronic device via the channel between the first electronic device and the at least one second electronic device, the wireless network configuration information may be transmitted to the at least one second electronic device via the Power Delivery (PD) protocol or the USB protocol in the channel.

When the first electronic device transmits the wireless network configuration information to at least one second electronic device, the at least one second electronic device can be in a started state or an unstarted state.

The first electronic device may first supply power to the at least one second electronic device through a channel between the first electronic device and the at least one second electronic device. When the first electronic device supplies power to the at least one second electronic device, one second electronic device may not be started and may be still in a shutdown state. Because of the input of electrical energy, a power module and a processing module (such as the embedded controller EC) in the second electronic device may be in a started state, and may be able to receive the wireless network configuration information transmitted by the first electronic device. The processing module may control the second electronic device to wirelessly connect to the third electronic device indicated by the wireless network configuration information based on the received wireless network configuration information. Alternatively, after receiving the wireless network configuration information, the processing module may control the second electronic device to start up, and after the startup is completed, the processing module may control the second electronic device to wirelessly connect to the third electronic device indicated by the wireless network configuration information based on the wireless network configuration information.

Alternatively, the first electronic device may supply power to the at least one second electronic device through the channel between the first electronic device and the at least one second electronic device. When the power supply condition meets the target condition, the first electronic device may obtain the status information of the at least one second electronic device through the channel to detect the at least one second electronic device based on the status information. When one second electronic device is turned on based on the detecting result, the second electronic device may obtain the wireless network configuration information transmitted by the first electronic device after powering on and, based on the wireless network configuration information, may be controlled to wirelessly connect to a third electronic device designated by the wireless network configuration information.

The third electronic device may be a server or another device designated by the wireless network configuration information.

In the data processing method provided by this embodiment, the channel between the first electronic device and the at least one second electronic device may be established. The first electronic device may supply power to the at least one second electronic device through the channel, and may obtain the status information of the at least one second electronic device through the channel in response to the first signal. The first signal may indicate that the power supply condition meets the target condition. The power may be supplied to the at least one second electronic device based on the status information. The wireless network configuration information may be obtained and transmitted to the at least one second electronic device, such that the at least one second electronic device is able to utilize the resources of the third electronic device, where the third electronic device is the device pointed to by the wireless network configuration information. Therefore, the first electronic device may supply power to the at least one second electronic device through the channel between it and the at least one second electronic device, obtain the status information of the at least one second electronic device, and detect the at least one second electronic device based on the status information. After the detect is completed, the first electronic device may send the obtained wireless network configuration information to the at least one second electronic device such that the at least one second electronic device is wirelessly connected to the third electronic device based on the wireless network configuration information, thereby realizing automatic control of the wireless network connection of the at least one second electronic device by the first electronic device, such that the at least one second electronic device is able to perform other detect or control based on the wireless network connection. The operation process may be simplified and the user experience may be improved.

In some embodiments, the data processing method may further include:

sending the wireless network configuration information to other first electronic devices, such that one second electronic device that has established a connection with the other first electronic devices is able to utilize resources of the third electronic device after the other first electronic devices obtain the wireless network configuration information, where the third electronic device is a device targeted by the wireless network configuration information.

After the first electronic device obtains the wireless network configuration information, the first electronic device may send the wireless network configuration information to one second electronic device that has a connection with the first electronic device such that the second electronic device is able to obtain the wireless network configuration information and establish a wireless connection with the third electronic device based on the wireless network configuration information to utilize the resources of the third electronic device. The first electronic device may further send the wireless network configuration information to the other

first electronic devices, such that one second electronic device that has a connection with the other first electronic devices is able to utilize the resources of the third electronic device.

The first electronic device may be an electronic device that is able to establish a connection with the at least one second electronic device, supply power to the at least one second electronic device via the connection, obtain the status information of the at least one second electronic device via the connection, and detect the at least one second electronic device based on the status information. The other first electronic devices may be similar to the first electronic device and may be also electronic devices that are able to establish a connection with the at least one second electronic device, supply power to the at least one second electronic device via the connection, obtain the status information of the at least one second electronic device via the connection, and detect the at least one second electronic device based on the status information.

The difference between the other first electronic devices and the first electronic device may be that at least one second electronic device with which the channel is established is different. For example, the first electronic device A1 establishes a channel with the second electronic device B1, the second electronic device B2, and the second electronic device B3. The first electronic device A2 establishes a channel with the second electronic device C1, the second electronic device C2, and the second electronic device C3.

When a large number of second electronic devices need to be detected, multiple first electronic devices may be provided, each of which is capable of connecting to some of the second electronic devices and detecting the second electronic devices connected thereto. Different first electronic devices may connect to different second electronic devices.

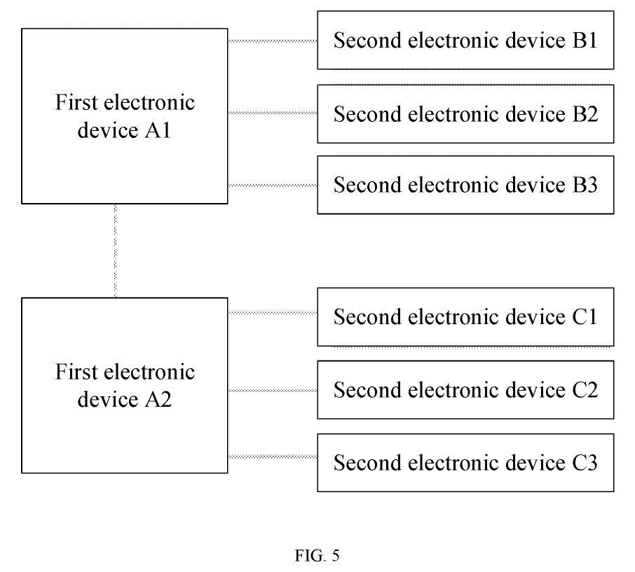

FIG. 5 is a schematic diagram of a system architecture for implementing the data processing method disclosed in this embodiment. The system may at least include: the first electronic device A1, the first electronic device A2, the second electronic device B1, the second electronic device B2, the second electronic device B3, the second electronic device C1, the second electronic device C2, and the second electronic device C3. The first electronic device A1 connects to and establishes channels with the second electronic device B1, the second electronic device B2, and the second electronic device B3, respectively. The first electronic device A2 connects to and establishes channels with the second electronic device C1, the second electronic device C2, and the second electronic device C3, respectively. When the number of second electronic devices increases, the number of first electronic devices may increase accordingly. As shown in FIG. 5, in one embodiment, each first electronic device may establish channels with three second electronic devices. Of course, in other embodiments, channels may be established with four or five second electronic devices. The embodiment shown in FIG. 5 is used as an example only to illustrate the present disclosure and does not limit the number of second electronic devices that can be established with one first electronic device.

Furthermore, the system architecture shown in FIG. 5 may further include a third electronic device D, which is the device targeted by the wireless network configuration information obtained by the first electronic device A1. The first electronic device A1 may first obtain the wireless network configuration information and then transmit it to the second electronic devices B1, B2, and B3 with which it has established a connection, such that the second electronic devices B1, B2, and B3 are all able to establish a wireless connection with the third electronic device D and utilize the resources of the third electronic device.

Further, the first electronic device A1 may also transmit the wireless network configuration information to other first electronic devices, such as the first electronic device A2. After receiving the wireless network configuration information from the first electronic device A1, the first electronic device A2 may transmit the wireless network configuration information to the second electronic devices C1, C2, and C3 with which it has established a connection, such that the second electronic devices C1, C2, and C3 are all able to establish a wireless connection with the third electronic device D and utilize the resources of the third electronic device, thereby ensuring that all second electronic devices are able to obtain the wireless network configuration information and establish wireless connections based on it.

The first electronic device may send the wireless network configuration information to other first electronic devices through a wireless Mesh (wireless network mesh) method.

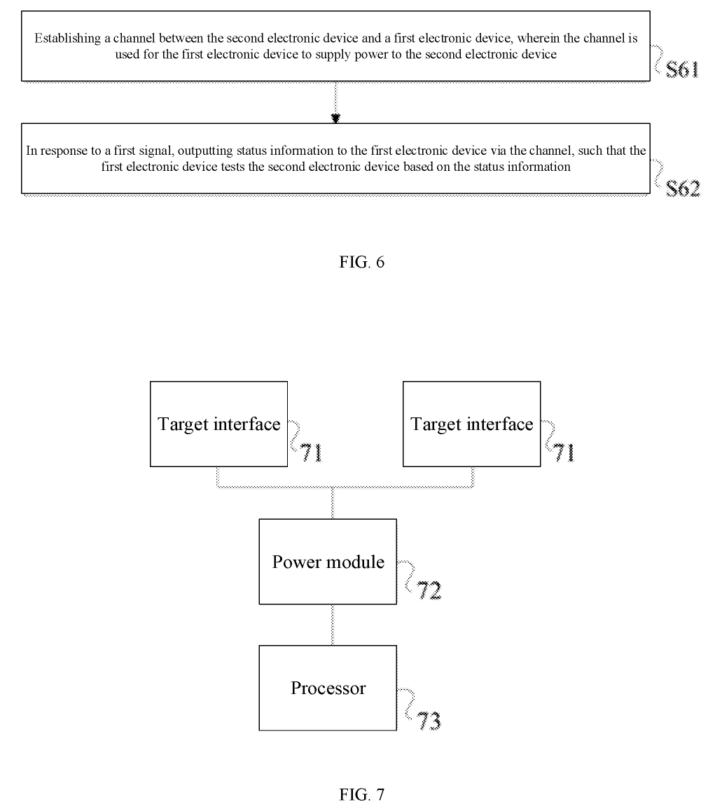

The present disclosure also provides a data processing method, which is applied to a second electronic device. As shown in FIG. 6, in one embodiment, the method may include:

S61: establishing a channel between the second electronic device and the first electronic device, where the channel is used for the first electronic device to supply power to the second electronic device; and

S62: in response to a first signal, outputting status information to the first electronic device via the channel, such that the first electronic device is able to detect the second electronic device based on the status information. The first signal may indicate that the power supply status meets the target condition.

When the second electronic device has not been used for a long time, it may need to be detected before use. When the second electronic device needs to be detected, it may be physically connected to the first electronic device which is capable of detecting the second electronic device. This physical connection may establish the channel between the first electronic device and the second electronic device.

The channel between the first electronic device and the second electronic device may transmit both signals and power. After the channel is established, the first electronic device may directly supply power to the second electronic device via the channel, allowing the second electronic device to receive power and enabling the first electronic device to detect the second electronic device.

When the first electronic device supplies power to the second electronic device through the channel, the power supply status may be monitored to determine whether it meets the target condition. When the target condition is not met, power may continue to be supplied to the second electronic device through the first electronic device. When the target condition is met, the subsequent detecting process may be initiated.

The monitoring of the power supply status may be performed by either the second electronic device or the first electronic device. When the second electronic device performs the monitoring, it may monitor the amount of power received by the second electronic device and compare the amount with a first threshold. When the amount of power reaches the first threshold, the target condition may be determined to be met. When the amount of power does not reach the first threshold, the target condition may be determined to be not met. Alternatively, in another embodiment, the second electronic device may monitor the duration of receiving power. When the duration reaches a second threshold, the target condition may be determined to be met. When the duration does not reach the second threshold, the target condition may be determined to be not met. For the embodiment where the monitoring of the power supply status by the first electronic device, references may be made to the previous embodiments and will not be further described here.

When it is determined that the power supply condition meets the target condition, the first signal may be generated. In response to the first signal, the second electronic device may transmit the status information of the second electronic device to the first electronic device via the channel between the first electronic device and the second electronic device, enabling the first electronic device to detect the second electronic device based on the status information of the second electronic device.

The status information may be information that is able to represent status of each component in the second electronic device. When the power supply condition meets the target condition, the second electronic device may detect the status information of each component within it and transmit the detected status information to the first electronic device via the channel between the first electronic device and the second electronic device. In this case, the first electronic device may no longer supply power to the second electronic device via the channel. Instead, the second electronic device may transmit the status information of the second electronic device to the first electronic device via the channel, allowing the first electronic device to detect the second electronic device based on the status information. Therefore, the detect of the second electronic device may be automatically completed via the channel between the first electronic device and the second electronic device, eliminating the need for manual user operation and simplifying the detection process.

In the data processing method provided by the present embodiment, the channel may be established between the second electronic device and the first electronic device, and the channel may be used for the first electronic device to supply power to the second electronic device. In response to the first signal, the second electronic device may output the status information to the first electronic device via the channel, enabling the first electronic device to detect the second electronic device based on the status information. The first signal may indicate that the power supply condition meets the target condition. The channel may be established between the second electronic device and the first electronic device, and the first electronic device may supply power to the second electronic device through the channel. When the power supply condition meets the target condition, the status information may be output to the first electronic device through the channel, such that the first electronic device is able to detect the second electronic device, thereby achieving the purpose of automatically detecting the second electronic device without the need for manual operation by the user, simplifying the operation process, and improving the operating experience.

In one embodiment, outputting the status information to the first electronic device through the channel may include:

obtaining the status information based on a processing module; processing the status information based on the power module, and outputting the status information to the first electronic device via the channel, where the processing includes packaging the status information based on a charging protocol.

Since the second electronic device has not been used for an extended period of time, to ensure electrical safety and the lifespan of the second electronic device, power to the second electronic device may be inevitably unavailable, or the battery within the second electronic device may be inevitably depleted. Therefore, power must first be supplied to the second electronic device such that the battery within the second electronic device is able to receive power. Once the battery within the second electronic device receives power, a detect of the second electronic device may be performed.

The first electronic device may supply power to the second electronic device via the channel between them. While the first electronic device is supplying power to the second electronic device, the second electronic device may not be powered on and may remain in a shutdown state. Because of the input of power, the power module and the processing module (e.g., an embedded controller EC) within the second electronic device may be powered on. At this point, the processing module within the second electronic device may detect the status of various components within the second electronic device to obtain the status information.

Since the second electronic device and the first electronic device transmit information via the channel which is a channel for power supply, the processing module of the second electronic device may be unable to directly transmit the status information it obtains to the first electronic device. For example, after the processing module of the second electronic device obtains the status information, it may send the status information to the power module of the second electronic device. The power module may process the status information and then transmit the processed status information to the first electronic device via the channel between the second electronic device and the first electronic device.

The power module may process the status information by packaging the status information based on the charging protocol. Only the information packaged by the power module based on the charging protocol may be able to be transmitted to the first electronic device via the channel, allowing the first electronic device to detect the second electronic device based on the status information.

Correspondingly, information transmitted from the first electronic device to the second electronic device via the channel between the first electronic device and the second electronic device may also need to be first parsed by the power module of the second electronic device before it is able to be analyzed and processed.

In one embodiment, the data processing method may further include:

acquiring a second signal transmitted by the first electronic device based on the power module and parsing it based on the charging protocol, and starting the device and entering the low-power mode based on the processing module.

After the second electronic device obtains the second signal transmitted via the channel between the first electronic device and the second electronic device, the power module of the second electronic device may first receive the second signal transmitted via the channel. The power module may parse the second signal based on the charging protocol and then transmit it to the processing module of the second electronic device, which analyzes and responds to the parsed second signal.

The second signal may be output by the first electronic device when it determines that the second electronic device is in a target state, in which the second electronic device is able to operate normally. For example, the first electronic device may detect the status information transmitted by the second electronic device and determine that the second electronic device is able to operate normally. At this point, the first electronic device may output the second signal, causing the second electronic device to respond to the second signal to start and enter the low-power mode.

The processing module of the second electronic device may receive the parsed second signal and control the second electronic device to start and enter the low-power mode.

In the low-power mode, the second electronic device may be able to continue to receive other signals from the first electronic device, allowing further detects or direct control of the second electronic device based on the other signals from the first electronic device. Alternatively, in some other embodiments, when the second electronic device is in the low-power mode, the second electronic device may no longer receive control or detect signals from the first electronic device, but instead may directly receive control or detection from the user or the server.

In some embodiments, the data processing method may also include:

obtaining wireless network configuration information sent by the first electronic device using the power module, parsing the wireless network configuration information based on the charging protocol, and establishing a connection with a third electronic device using the processing module to utilize the resources of the third electronic device, where the third electronic device is a device targeted by the wireless network configuration information.

The first electronic device may not only supply power to the second electronic device and send the second signal to the second electronic device through the channel between the first electronic device and the second electronic device, but may also send the wireless network configuration information to the second electronic device through the channel. The wireless network configuration information may be information that enables the second electronic device to wirelessly connect to the third electronic device and utilize the resources of the third electronic device. The third electronic device may be the device targeted by the wireless network configuration information.

When the first electronic device transmits the wireless network configuration information to the second electronic device via the channel between the first electronic device and the second electronic device, the first electronic device may transmit the wireless network configuration information to the second electronic device via the charging protocol. Upon receiving the wireless network configuration information, the power module of the second electronic device may first parse it using the charging protocol and then transmit the parsed wireless network configuration information to the processing module for analysis and processing.

After receiving the parsed wireless network configuration information, the processing module may control the second electronic device to establish a connection with the third electronic device based on the parsed wireless network configuration information, enabling the second electronic device to utilize the resources of the third electronic device.

In the data processing method provided by this embodiment, after obtaining the information transmitted via the channel between the first electronic device and the second electronic device, the received information may be first parsed by the power module. After parsing the information may be transmitted to the processing module for processing, thereby enabling data transmission via the channel for power supply between the first and second electronic devices. This may ensure that the second electronic device may be detected and further controlled while only the power module and processing module in the second electronic device are operating, eliminating the need for manual user operation and improving efficiency.

The present disclosure also provides an electronic device. As shown in FIG. 7 which is a structural diagram of an electronic device, in one embodiment, the electronic device may include at least one target interface 71, a power module 72, and a processor 73.

The at least one target interface 71 may be configured to connect to at least one second electronic device and establish a channel with the at least one second electronic device.

The power module 72 may be configured to supply power to the at least one second electronic device via the channel.

The processor 73 may be configured to obtain status information of the at least one second electronic device via the channel in response to a first signal and then detect the at least one second electronic device based on the status information, where the first signal indicates that the power supply meets a target condition.

The electronic device provided in this embodiment may correspond to the first electronic device in the aforementioned embodiments.

The electronic device disclosed in this embodiment may be implemented based on the data processing method disclosed in the aforementioned embodiments and will not be further described here.

The electronic device provided by this embodiment may include the at least one target interface, the power module, and the processor. The at least one target interface may be used to connect to at least one second electronic device and establish a channel between the first electronic device and the at least one second electronic device. The power module may be used to supply power to the at least one second electronic device through the channel. The processor may be used to obtain the status information of the at least one second electronic device through the channel in response to the first signal. The first signal may indicate that the power supply condition meets a target condition. The at least one second electronic device may be detected based on the status information. When detecting the at least one second electronic device through the first electronic device, when the channel is established between the first electronic device and the at least one second electronic device, the first electronic device may first supply power to the at least one second electronic device through the channel. When the power supply condition meets the target condition, the status information of the at least one second electronic device may be obtained through the channel, and the at least one second electronic device may be detected based on the status information. The entire process may not require manual user operation. The at least one second electronic device to be detected may be powered through the channel established between the devices, and the status information may be transmitted through the same channel, thereby realizing an automatic detecting process and improving the detection efficiency of the at least one second electronic device.

The device embodiments described above are merely illustrative. The units described as separate components may or may not be physically separate, and the components shown as units may or may not be physical units. They may be located in a single location or distributed across multiple network units. Some or all of the modules can be selected to achieve the objectives of the present embodiments as needed. Furthermore, in the drawings of the device embodiments provided herein, the connection relationships between modules indicate a communication connection between them, which can be implemented as one or more communication buses or signal lines.

From the description of the embodiments above, those skilled in the art will clearly understand that the present disclosure can be implemented using software plus necessary general-purpose hardware, or alternatively, using dedicated hardware, including application-specific integrated circuits, dedicated CPUs, dedicated memories, or dedicated components. Generally speaking, any function performed by a computer program can be easily implemented using corresponding hardware. Furthermore, the specific hardware structures used to implement the same function can vary, such as analog circuits, digital circuits, or dedicated circuits. However, for the present disclosure, software implementation is often the preferred implementation method. Based on this understanding, the technical solution of the present disclosure, or parts that contributes to the prior art, can be embodied in the form of a software product, which is stored in a readable storage medium, such as a computer floppy disk, USB flash drive, mobile hard disk, ROM, RAM, magnetic disk or optical disk, etc., and includes a number of instructions for enabling a computer device (which can be a personal computer, training equipment, or network equipment, etc.) to execute the methods described in each embodiment of the present disclosure.

The above embodiments can be implemented in whole or in part by software, hardware, firmware or any combination thereof. When being implemented using software, it can be implemented in whole or in part in the form of a computer program product.

The computer program product includes one or more computer instructions. When the computer program instructions are loaded and executed on a computer, the process or function described in the embodiments of the present disclosure is implemented in whole or in part. The computer can be a general-purpose computer, a special-purpose computer, a computer network, or other programmable device. The computer instructions may be stored in a computer-readable storage medium or transmitted from one computer-readable storage medium to another computer-readable storage medium. For example, the computer instructions may be transmitted from one website, computer, training device, or data center to another website, computer, training device, or data center via a wired (e.g., coaxial cable, optical fiber, digital subscriber line (DSL)) or wireless (e.g., infrared, wireless, microwave, etc.) method. The computer-readable storage medium may be any available medium that can be accessed by a computer or a data storage device such as a training device or data center that includes one or more available media. The available medium may be a magnetic medium (e.g., a floppy disk, a hard disk, a magnetic tape), an optical medium (e.g., a DVD), or a semiconductor medium (e.g., a solid-state drive (SSD)).

The various specific technical features described in the specific embodiments can be combined in any suitable manner without contradiction. For example, different embodiments and technical solutions can be formed by combining different specific technical features. In order to avoid unnecessary repetition, the various possible combinations of the specific technical features in this application will not be described separately.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

WHAT IS CLAIMED IS:

1. A data processing method applied to a first electronic device, comprising:
establishing a channel between the first electronic device and at least one second electronic device;
controlling the first electronic device to supply power to the at least one second electronic device through the channel;
obtaining status information of the at least one second electronic device through the channel in response to a first signal, wherein the first signal indicates that the power supply condition meets a target condition; and
detecting the at least one second electronic device based on the status information.

2. The method according to claim 1, further comprising one of:
in response to supplied power of the at least one second electronic device reaching a first threshold, determining the power supply condition to meet the target condition; or
in response to a duration for which the first electronic device supplies power to the at least one second electronic device reaching a second threshold, determining the power supply condition to meet the target condition.

3. The method according to claim 1, further comprising:
in response to detecting that the at least one second electronic device is in a target state, outputting a second signal to the at least one second electronic device, such that the at least one second electronic device starts up and enters a low power consumption, wherein the at least one second electronic device in the target state is able to operate normally; and
controlling, by the first electronic device, the at least one second electronic device in the low power consumption mode.

4. The method according to claim 1, further comprising:
obtaining wireless network configuration information; and
sending the wireless network configuration information to the at least one second electronic device, such that the at least one second electronic device is able to utilize resources of a third electronic device, wherein the third electronic device is a device to which the wireless network configuration information points.

5. The method according to claim 4, further comprising:
sending the wireless network configuration information to another first electronic device such that after the other first electronic device obtains the wireless network configuration information, second electronic devices that establish a channel with the other first electronic device are able to use the resources of the third electronic device.

6. The method according to claim 1, wherein:
in response to the first signal, the at least one second electronic device outputs status information to the first electronic device via the channel, such that the first electronic device detects the second electronic device based on the status information.

7. The method according to claim 1, wherein the at least one second electronic device is configured to obtain the status information based on a processing module; and process the status information based on a power module and output the status information to the first electronic device through the channel, wherein the status information is processed by packaging the status information based on a charging protocol.

8. The method according to claim 7, wherein the at least one second electronic device is configured to obtain a second signal through the power module and parse the second signal sent by the first electronic device based on the charging protocol.

9. The method according to claim 7, wherein the at least one second electronic device is configured to obtaining wireless network configuration information sent by the first electronic device through the power module, and parse the wireless network configuration information based on the charging protocol; and establish a connection with a third electronic device to utilize the resources of the third electronic device through the processing module, wherein the third electronic device is a device pointed to by the wireless network configuration information.

10. An electronic device, comprising:
at least one target interface, configured to connect to at least one second electronic device and establish a channel with the at least one second electronic device;
a power supply module, configured to supply power to the at least one second electronic device through the channel; and
one or more processors, configured to perform obtaining status information of the at least one second electronic device through the channel in response to a first signal indicating that the power supply condition meets a target condition; and detecting the at least one second electronic device based on the status information.

11. The electronic device according to claim 10, wherein the one or more processors are further configured to perform one of:
in response to supplied power of the at least one second electronic device reaching a first threshold, determining the power supply condition to meet the target condition; or
in response to a duration for which the first electronic device supplies power to the at least one second electronic device reaching a second threshold, determining the power supply condition to meet the target condition.

12. The electronic device according to claim 10, wherein the one or more processors are further configured to perform:
in response to it is detected that the at least one second electronic device is in a target state, outputting a second signal to the at least one second electronic device, such that the at least one second electronic device starts up and enters a low power consumption, wherein the at least one second electronic device in the target state is able to operate normally; and
controlling, by the first electronic device, the at least one second electronic device in the low power consumption mode.

13. The electronic device according to claim 10, wherein the one or more processors are further configured to perform:
obtaining wireless network configuration information; and
sending the wireless network configuration information to the at least one second electronic device, such that the at least one second electronic device is able to utilize resources of a third electronic device, wherein the third electronic device is a device to which the wireless network configuration information points.

14. The electronic device according to claim 13, wherein the one or more processors are further configured to perform:
sending the wireless network configuration information to another first electronic device such that after the other first electronic device obtains the wireless network configuration information, second electronic devices that establish a channel with the other first electronic device are able to use the resources of the third electronic device.

15. A non-transitory computer readable storage medium containing a computer program that, when being executed, causes at least one processor to perform:
establishing a channel between the first electronic device and at least one second electronic device;
controlling the first electronic device to supply power to the at least one second electronic device through the channel;
obtaining status information of the at least one second electronic device through the channel in response to a first signal, wherein the first signal indicates that the power supply condition meets a target condition; and
detecting the at least one second electronic device based on the status information.

16. The storage medium according to claim 15, wherein the at least one processor is further configured to perform one of:
in response to supplied power of the at least one second electronic device reaching a first threshold, determining the power supply condition to meet the target condition; or
in response to a duration for which the first electronic device supplies power to the at least one second electronic device reaching a second threshold, determining the power supply condition to meet the target condition.

17. The storage medium according to claim 15, wherein the at least one processor is further configured to perform:
in response to detecting that the at least one second electronic device is in a target state, outputting a second signal to the at least one second electronic device, suc that the at least one second electronic device start up and enter a low power consumption, wherein the at least one second electronic device in the target state is able to operate normally; and
controlling, by the first electronic device, the at least one second electronic device in the low power consumption mode.

18. The storage medium according to claim 15, wherein the at least one processor is further configured to perform:
obtaining wireless network configuration information; and
sending the wireless network configuration information to the at least one second electronic device, such that the at least one second electronic device is able to utilize resources of a third electronic device, wherein the third electronic device is a device to which the wireless network configuration information points.

19. The storage medium according to claim 15, wherein the at least one processor is further configured to perform:
sending the wireless network configuration information to another first electronic device such that after the other first electronic device obtains the wireless network configuration information, second electronic devices that establish a channel with the other first electronic device are able to use the resources of the third electronic device.
